(19) United States
(12) Patent Application Publication
(10) Pub. No.: US 2024/0317005 A1
(43) Pub. Date: Sep. 26, 2024

(54) HYDRAULIC ACTIVE SUSPENSION AND VEHICLE HAVING HYDRAULIC ACTIVE SUSPENSION

(71) Applicant: BYD COMPANY LIMITED, Shenzhen (CN)

(72) Inventors: Haolun XU, Shenzhen (CN); Yinsheng LIAO, Shenzhen (CN); Hongzhou ZHANG, Shenzhen (CN); Taishuo HUANG, Shenzhen (CN); Lei ZHANG, Shenzhen (CN)

(21) Appl. No.: 18/676,557

(22) Filed: May 29, 2024

Related U.S. Application Data
(63) Continuation of application No. PCT/CN2022/144046, filed on Dec. 30, 2022.

(30) Foreign Application Priority Data
Dec. 30, 2021 (CN) 202123435005.1

(51) Int. Cl. B60G 13/08; B60G 17/08

(52) U.S. Cl. CPC B60G 13/08; B60G 17/08; B60G 2202/24; B60G 2206/41

(57) ABSTRACT

A hydraulic active suspension for a vehicle includes: a shock absorber, a common channel, an accumulator module, and a liquid storage apparatus. The shock absorber has a housing, a piston, and a piston rod. The housing is adapted to be connected to a wheel or an axle. The piston is located in the housing and defines an upper chamber and a lower chamber of the shock absorber. One end of the piston rod is connected to the piston. The other end of the piston rod projects out of the housing and is adapted to be connected to a body. Both the liquid storage apparatus and the accumulator module are in communication with the lower chamber through the common channel. The liquid storage apparatus is configured to adjust a height of the vehicle. The accumulator module is configured to adjust at least one of stiffness and damping of the shock absorber.

### CROSS-REFERENCE TO RELATED APPLICATIONS

The present disclosure is a bypass continuation application of PCT International Application No. PCT/CN2022/144046, filed on Dec. 30, 2022, which claims priority to Chinese Patent Application No. 202123435005.1, filed on Dec. 30, 2021. The entire contents of the above-referenced applications are incorporated herein by reference.

### FIELD

The present disclosure relates to the field of vehicles, and particularly, to a hydraulic active suspension and a vehicle having the same.

### BACKGROUND

A suspension is an apparatus transmitting an interaction force between a body and an axle, is one of four components of a vehicle, and is a key component that affects driving performance of the vehicle. The suspension can transmit a force and torque fed back by a road surface, attenuate wheel vibration, ease impact, and improve driving experience of a driver, so that the vehicle can obtain an ideal motion characteristic and a stable driving capability. Suspensions in the related arts mostly include springs, guide mechanisms, shock absorbers, and the like. A damping coefficient of the shock absorber and stiffness of the spring are fixed. Consequently, comfort and operation stability cannot be both considered.

### SUMMARY

The present disclosure is intended to resolve one of technical problems in the related art at least to some extent.

Therefore, an objective of the present disclosure is to provide a hydraulic active suspension, thereby effectively resolving a contradiction between vehicle comfort and operation stability. The structure of the entire hydraulic active suspension is compact, thereby facilitating space arrangement of a complete vehicle.

The present disclosure further provides a vehicle having the foregoing hydraulic active suspension.

A hydraulic active suspension according to embodiments of the present disclosure is configured for a vehicle and includes: a shock absorber, a common channel, an accumulator module, and a liquid storage apparatus. The shock absorber has a housing, a piston, and a piston rod. The housing is adapted to be connected to a wheel or an axle. The piston is located in the housing and defines an upper chamber and a lower chamber of the shock absorber. One end of the piston rod is connected to the piston. The other end of the piston rod projects out of the housing and is adapted to be connected to a body. Both the liquid storage apparatus and the accumulator module are in communication with the lower chamber through the common channel. The liquid storage apparatus is configured to adjust a height of the vehicle. The accumulator module is configured to adjust at least one of stiffness and damping of the shock absorber.

According to the hydraulic active suspension in the embodiments of the present disclosure, the body height can be adjusted, and vehicle operation stability can be improved without compromising vehicle comfort, thereby effectively resolving a contradiction between the vehicle comfort and the operation stability. In addition, the stiffness and the damping can be further adjusted, so that the vehicle on which the hydraulic active suspension is arranged drives more stably. In addition, a flow path between the liquid storage apparatus and the lower chamber overlaps a flow path between the accumulator module and the lower chamber, that is, a pipeline for adjusting the body height overlaps a pipeline for adjusting the stiffness and the damping. Therefore, the number of connection pipelines can be reduced, so that the structure of the entire hydraulic active suspension is compact, thereby facilitating space arrangement of the complete vehicle.

In some embodiments of the present disclosure, a first end of the common channel is in communication with the lower chamber, a second end of the common channel is in communication with the liquid storage apparatus, a module connection part is arranged on the common channel, and the module connection part is located between the first end and the second end and is configured to be in communication with the accumulator module.

In some embodiments of the present disclosure, a first control valve is arranged on the common channel, and the first control valve is arranged between the second end and the module connection part.

In some embodiments of the present disclosure, the module connection part includes a first connection point, the accumulator module includes a first accumulator and a second control valve, the first accumulator is in communication with the first connection point, the second control valve is arranged between the first connection point and the lower chamber, and the second control valve is one of an adjustment valve, a cutoff valve, and a cutoff adjustment valve; and when the second control valve is the adjustment valve, the second control valve is configured to adjust opening to adjust the damping of the shock absorber; when the second control valve is the cutoff valve, the second control valve is configured to adjust the stiffness; or when the second control valve is the cutoff adjustment valve, the second control valve is configured to adjust the stiffness and the damping of the shock absorber.

In some embodiments of the present disclosure, the module connection part further includes a second connection point, the accumulator module includes a second accumulator and a third control valve, the second accumulator is in communication with the second connection point, and the third control valve is arranged between the second accumulator and the second connection point and selectively communicates the second connection point with the second accumulator.

In some embodiments of the present disclosure, the module connection part includes a first connection point and a second connection point, the accumulator module includes a first accumulator, a second accumulator, a second control valve, and a third control valve, the first accumulator is connected to the first connection point, the second accumulator is connected to the second connection point, the second control valve is connected between the first connection point and the lower chamber, the third control valve is arranged between the second accumulator and the second connection point, the second control valve is the adjustment valve to adjust the damping of the shock absorber, and the third control valve is the cutoff valve to adjust the stiffness of the shock absorber.

In some embodiments of the present disclosure, the first connection point is arranged on a side of the second connection point away from the second end.

In some embodiments of the present disclosure, a fourth control valve is arranged between the first connection point and the second connection point.

In some embodiments of the present disclosure, the shock absorber is a front-axle shock absorber, a third connection point is arranged between the module connection part and the first end, the hydraulic active suspension further includes a third accumulator, and the third accumulator is in communication with the third connection point.

In some embodiments of the present disclosure, the shock absorber is a rear-axle shock absorber, the module connection part further includes a third connection point, the third connection point is located between the first connection point and the second connection point, the accumulator module includes a third accumulator, and the third accumulator is in communication with the third connection point.

A vehicle according to embodiments of the present disclosure includes the hydraulic active suspension according to any one of the foregoing embodiments of the present disclosure.

According to the vehicle in the embodiments of the present disclosure, the hydraulic active suspension according to any one of the foregoing embodiments is arranged, so that the body height can be adjusted, and vehicle operation stability can be improved without compromising vehicle comfort, thereby effectively resolving a contradiction between the vehicle comfort and the operation stability. In addition, the stiffness and the damping can be further adjusted, so that the vehicle on which the hydraulic active suspension is arranged drives more stably. In addition, a flow path between the liquid storage apparatus and the lower chamber overlaps a flow path between the accumulator module and the lower chamber, that is, a pipeline for adjusting the body height overlaps a pipeline for adjusting the stiffness and the damping. Therefore, the number of connection pipelines can be reduced, so that the structure of the entire hydraulic active suspension is compact, thereby facilitating space arrangement of the complete vehicle.

Other aspects and advantages of the present disclosure will be given in the following descriptions, some of which will become apparent from the following descriptions or can be learned from practices of the present disclosure.

### BRIEF DESCRIPTION OF THE DRAWINGS

FIG. 1 is a schematic diagram of a hydraulic active suspension according to an embodiment of the present disclosure; and

FIG. 2 is a schematic diagram of a shock absorber according to an embodiment of the present disclosure.

### REFERENCE SIGNS

hydraulic active suspension 1000;
liquid receiver 1;
shock absorber 200, housing 201, upper chamber 2011, lower chamber 2012, piston 202, piston rod 203, and oil channel 204;
first control valve 3;
second control valve 8;
first accumulator 9;
second accumulator 10 and third control valve 11;
fourth control valve 12; and
control pump 26, control valve body 260, drive motor 261, oil return valve 27, one-way valve 28, pressure-stabilizing accumulator 29, third accumulator 30, and pressure relief valve 31.

### DETAILED DESCRIPTION

Embodiments of the present disclosure are described in detail below, and examples of the embodiments are shown in accompanying drawings, where the same or similar elements or the elements having same or similar functions are denoted by the same or similar reference signs throughout the description. The embodiments described below with reference to the accompanying drawings are examples, and to explain the present disclosure and cannot be construed as limitations to the present disclosure.

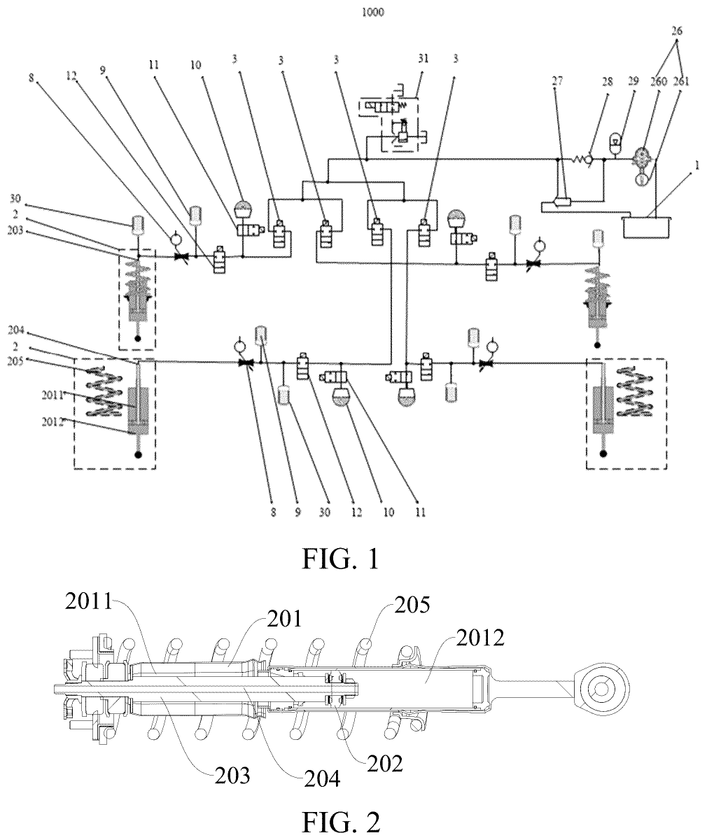

The following describes a hydraulic active suspension 1000 according to embodiments of the present disclosure with reference to FIG. 1 and FIG. 2. The hydraulic active suspension 1000 is configured for a vehicle. The hydraulic active suspension 1000 is arranged on a body, and the hydraulic active suspension 1000 is further connected to a wheel or an axle.

As shown in FIG. 1 and FIG. 2, the hydraulic active suspension 1000 according to the embodiments of the present disclosure includes: a shock absorber 200, a common channel, an accumulator module, and a liquid storage apparatus. The shock absorber 200 has a housing 201, a piston 202, and a piston rod 203. The housing 201 is adapted to be connected to the wheel or the axle. The piston 202 is located in the housing 201 and defines an upper chamber 2011 and a lower chamber 2012 of the shock absorber 200. One end of the piston rod 203 is connected to the piston 202. The other end of the piston rod 203 projects out of the housing 201 and is adapted to be connected to the body. Both the liquid storage apparatus and the accumulator module are in communication with the lower chamber 2012 through the common channel. The liquid storage apparatus is configured to adjust a body height of the vehicle. The accumulator module is configured to adjust at least one of stiffness and damping of the shock absorber 200.

Specifically, the liquid storage apparatus is in communication with the lower chamber 2012 through the common channel, and the accumulator module is also in communication with the lower chamber 2012 through the common channel, that is, a flow path between the liquid storage apparatus and the lower chamber 2012 overlaps a flow path between the accumulator module and the lower chamber 2012, that is, a pipeline for adjusting the body height overlaps a pipeline for adjusting the stiffness and the damping. Both the body height and at least one of the stiffness and the damping can be adjusted through the common channel. Therefore, the number of connection pipelines can be reduced, so that the structure of the entire hydraulic active suspension 1000 is compact, thereby facilitating space arrangement of the complete vehicle.

It can be further understood that oil in the liquid storage apparatus can enter the lower chamber 2012 through the common channel. When the piston rod 203 moves downward to make a volume in the lower chamber 2012 smaller, oil in the lower chamber 2012 may be discharged to the liquid storage apparatus through the common channel.

Specifically, the hydraulic active suspension 1000 has a lifting mode and a height reduction mode. In the lifting mode, oil in the liquid storage apparatus can enter the common channel, and the hydraulic oil entering the common channel flows into the lower chamber 2012, so that hydraulic pressure in the lower chamber 2012 increases and therefore the piston 202 moves upward. When the piston 202 moves upward, the piston rod 203 is driven to move upward, thereby lifting the body.

In the height reduction mode, oil can flow out of the lower chamber 2012 to flow to the liquid storage apparatus through the common channel, so that hydraulic pressure in the lower chamber 2012 of the shock absorber 200 decreases and therefore drives the piston 202 to move downward. When the piston 202 moves downward, the piston rod 203 is driven to move downward, to drive the body to move downward, thereby reducing the body height of the vehicle.

A vehicle may encounter various road conditions in a driving process. Once a suspension system of a vehicle in the related arts is selected, the suspension system cannot be adjusted in a driving process of the vehicle. Therefore, a conventional suspension can ensure that a vehicle achieves optimal performance matching under a road and speed condition, and can passively withstand a force of the ground on a body. Suspension parameters cannot be changed based on different roads and vehicle speeds, and the force of the ground on the body cannot be actively controlled.

According to the hydraulic active suspension 1000 in the embodiments of the present disclosure, the body height can be adjusted based on a road condition or the like. For example, When the vehicle passes through a relatively rugged mountain road, the vehicle can enter the lifting mode, so that a center of mass of the vehicle can be lifted, thereby improving vehicle driving stability. When impact of the body on a driving speed needs to reduced, the vehicle can enter the height reduction mode, so that the center of mass of the vehicle is lowered. Certainly, it can be understood that the foregoing descriptions are merely example descriptions, and the body height can be alternatively adjusted based on an actual requirement in a driving process.

It should be explained that the accumulator module plays a role of energy storage, that is, oil can flow into the accumulator module for energy storage. When the hydraulic active suspension 1000 needs oil, oil in the accumulator module is discharged for supply.

Specifically, when the accumulator module is configured to adjust the damping of the shock absorber 200, a flow amount of oil in the common channel (an amount of oil entering the shock absorber 200) can be adjusted to adjust the damping. When the accumulator module is configured to adjust the stiffness of the shock absorber 200, the common channel is communicated with the accumulator module, or communication between the accumulator module and the common channel is broken. Therefore, an adjustment function of the hydraulic active suspension 1000 can be enhanced, so that the vehicle on which the hydraulic active suspension 1000 is arranged drives more stably.

According to the hydraulic active suspension 1000 in the embodiments of the present disclosure, the body height can be adjusted, and vehicle operation stability can be improved without compromising vehicle comfort, thereby effectively resolving a contradiction between the vehicle comfort and the operation stability. In addition, the stiffness and the damping can be further adjusted, the vehicle on which the hydraulic active suspension 1000 is arranged drives more stably. In addition, a flow path between the liquid storage apparatus and the lower chamber 2012 overlaps a flow path between the accumulator module and the lower chamber 2012. Therefore, the number of connection pipelines can be reduced, so that the structure of the entire hydraulic active suspension 1000 is compact, thereby facilitating space arrangement of the complete vehicle.

In some embodiments of the present disclosure, a first end of the common channel is in communication with the lower chamber 2012, a second end of the common channel is in communication with the liquid storage apparatus, a module connection part is arranged on the common channel, and the module connection part is located between the first end and the second end and is configured to be in communication with the accumulator module. That is, the accumulator module is connected on a connection path between the liquid storage apparatus and the shock absorber. Therefore, the number of connection pipelines can be further reduced, so that the structure of the entire hydraulic active suspension 1000 structure is more compact.

Optionally, as shown in FIG. 1, a first control valve 3 is arranged on the common channel, and the first control valve 3 is arranged between the second end and the module connection part. Therefore, the first control valve 3 is arranged, so that when the first control valve 3 is closed, communication between the liquid storage apparatus and the accumulator module is broken, and oil in the liquid storage apparatus cannot flow to the accumulator module and the shock absorber 200. In this case, the stiffness and/or the damping of the shock absorber 200 can be adjusted by using the accumulator module. When the first control valve 3 is opened, oil in the liquid storage apparatus can flow to the accumulator module for energy storage, or the body height of the vehicle can be adjusted by using the liquid storage apparatus. Therefore, a mode of the hydraulic active suspension 1000 can be adjusted based on a requirement.

As shown in FIG. 1, in some embodiments of the present disclosure, the module connection part includes a first connection point, the accumulator module includes a first accumulator 9 and a second control valve 8, the first accumulator 9 is in communication with the first connection point, the second control valve 8 is arranged between the first connection point and the lower chamber 2012, and the second control valve 8 is one of an adjustment valve, a cutoff valve, and a cutoff adjustment valve. When the second control valve 8 is the adjustment valve, the second control valve 8 is configured to adjust opening to adjust the damping of the shock absorber 200. When the second control valve 8 is the cutoff valve, the second control valve 8 is configured to adjust the stiffness. When the second control valve 8 is the cutoff adjustment valve, the second control valve 8 is configured to adjust the stiffness and the damping of the shock absorber 200.

Specifically, the first accumulator 9 can store energy. When the second control valve 8 is the cutoff adjustment valve and is in an open state or when the second control valve 8 is the adjustment valve, when the opening of the second control valve 8 is reduced and therefore an amount of oil that can flow through the common channel is reduced, a flow path from the shock absorber to the common channel becomes narrower, and damping is relatively large. When the opening of the second control valve 8 is increased, the flow path from the shock absorber to the common channel becomes wider, and damping is relatively small. Therefore, through cooperation between the first accumulator 9 and the second control valve 8, reliability of damping adjustment of the hydraulic active suspension 1000 can be ensured, thereby ensuring that an amount of oil flowing through the common channel matches needed damping. In other words, a flow amount of oil in the corresponding common channel can be adjusted by using the second control valve 8. Therefore, damping of the corresponding common channel can be adjusted, to adjust damping of the hydraulic active suspension 1000, so that the damping of the hydraulic active suspension 1000 can be adjusted based on an actual case, for example, based on a road condition, to ensure that the damping of the hydraulic active suspension 1000 can meet a shock absorption requirement, thereby effectively resolving the contradiction between the vehicle comfort and the operation stability.

When the second control valve 8 is the cutoff valve or the second control valve 8 is the cutoff adjustment valve, when the second control valve 8 is in a closed state, the shock absorber 200 is disconnected from the first accumulator 9, oil in the shock absorber 200 cannot be discharged to the first accumulator 9, and oil in the first accumulator 9 cannot be discharged to the shock absorber 200, so that the stiffness of the shock absorber 200 can be improved.

In some embodiments of the present disclosure, as shown in FIG. 1, the module connection part further includes a second connection point, the accumulator module includes a second accumulator 10 and a third control valve 11, the second accumulator 10 is in communication with the second connection point, and the third control valve 11 is arranged between the second accumulator 10 and the second connection point and selectively communicates the second connection point with the second accumulator 10. Specifically, when the third control valve 11 is opened, oil in the second accumulator 10 can be discharged to the lower chamber 2012 of the shock absorber 200. When the third control valve 11 is closed, the second accumulator 10 is disconnected from the shock absorber 200. Therefore, oil in the shock absorber 200 cannot be discharged to the second accumulator 10, and oil in the second accumulator 10 cannot be discharged to the shock absorber 200, so that the stiffness of the shock absorber 200 can be improved.

As shown in FIG. 1, in some embodiments of the present disclosure, the module connection part includes a first connection point and a second connection point, the accumulator module includes a first accumulator 9, a second accumulator 10, a second control valve 8, and a third control valve 11, the first accumulator 9 is connected to the first connection point, the second accumulator 10 is connected to the second connection point, the second control valve 8 is connected between the first connection point and the lower chamber 2012, the third control valve 11 is arranged between the second accumulator 10 and the second connection point, the second control valve 8 is the adjustment valve to adjust the damping of the shock absorber 200, and the third control valve 11 is the cutoff valve to adjust the stiffness of the shock absorber 200.

Specifically, when opening of the second control valve 8 is reduced and therefore an amount of oil that can flow through the common channel is reduced, a flow path from the shock absorber to the common channel becomes narrower, and damping is relatively large. When the opening of the second control valve 8 is increased, the flow path from the shock absorber to the common channel becomes wider, and damping is relatively small. Therefore, through cooperation between the first accumulator 9 and the second control valve 8, reliability of damping adjustment of the hydraulic active suspension 1000 can be ensured, thereby ensuring that an amount of oil flowing through the common channel matches needed damping. In other words, a flow amount of oil in the corresponding common channel can be adjusted by using the second control valve 8. Therefore, damping of the corresponding common channel can be adjusted, to adjust damping of the hydraulic active suspension 1000, so that the damping of the hydraulic active suspension 1000 can be adjusted based on an actual case, for example, based on a road condition, to ensure that the damping of the hydraulic active suspension 1000 can meet a shock absorption requirement, thereby effectively resolving the contradiction between the vehicle comfort and the operation stability.

When the third control valve 11 is opened, oil in the second accumulator 10 can be discharged to the lower chamber 2012 of the shock absorber 200. When the third control valve 11 is closed, the second accumulator 10 is disconnected from the shock absorber 200. Therefore, oil in the shock absorber 200 cannot be discharged to the second accumulator 10, and oil in the second accumulator 10 cannot be discharged to the shock absorber 200, so that the stiffness of the shock absorber 200 can be improved.

Optionally, the first connection point is arranged on a side of the second connection point away from the second end.

In some embodiments of the present disclosure, a fourth control valve 12 is arranged between the first connection point and the second connection point. Therefore, the number of accumulators in communication with the shock absorber 200 can be controlled through opening or closing of the fourth control valve 12, to adjust the stiffness or the damping of the shock absorber 200.

In some embodiments of the present disclosure, as shown in FIG. 1, the shock absorber 200 is a front-axle shock absorber 200, a third connection point is arranged between the module connection part and the first end, the hydraulic active suspension 1000 further includes a third accumulator 30, and the third accumulator 30 is in communication with the third connection point. It can be understood that, in a driving process of the vehicle, if the vehicle is hit by a bump or the like, oil in a lower chamber 2012 of each shock absorber 200 can enter a third accumulator 30 through a common channel to store energy, to implement fast pressure reduction. It can be further understood that, when the vehicle encounters a relatively large obstacle, in principle, a front-axle wheel first encounters the obstacle. Therefore, the third accumulator 30 connected to the front-axle shock absorber 200 is arranged between the module connection part and the first end, so that a fast response can be implemented.

In some embodiments of the present disclosure, as shown in FIG. 1, the shock absorber 200 is a rear-axle shock absorber 200, the module connection part further includes a third connection point, the third connection point is located between the first connection point and the second connection point, the accumulator module includes a third accumulator 30, and the third accumulator 30 is in communication with the third connection point. Specifically, after the rear-axle third accumulator 30 is arranged between the first accumulator 9 and the second accumulator 10, when oil flows out of the lower chamber 2012, damping is performed before pressure relief, thereby helping improve comfort.

In some embodiments of the present disclosure, the liquid storage apparatus includes a liquid receiver 1, a control pump 26, a one-way valve 28, and an oil return valve 27. A liquid outlet of the liquid receiver 1 is connected to the common channel through a liquid outlet channel. The control pump 26 and the one-way valve 28 are connected on the liquid outlet channel in series to communicate or cut off the liquid outlet channel. A liquid inlet of the liquid receiver 1 is connected to the common channel through a liquid return channel, and the oil return valve 27 is connected on the liquid return channel in series to communicate or cut off the liquid return channel. Specifically, the liquid receiver 1 has an independent liquid return channel and liquid outlet channel. When liquid discharge is needed, the control pump 26 is opened and the oil return valve 27 is in a closed state, and the control pump 26 directs oil to the common channel. When liquid return is needed, the control pump 26 is closed and the oil return valve 27 is opened, so that oil from the common channel can flow to the liquid receiver 1 through the oil return valve 27. During liquid return, due to existence of the one-way valve 28, oil can be effectively prevented from flowing to the control pump 26, to prevent the oil from flowing to the liquid outlet through the control pump 26 when an accident occurs on the control pump 26. This ensures reliable liquid discharge and liquid return.

In some examples of the present disclosure, as shown in FIG. 1, the control pump 26 includes a control valve body 260 and a drive motor 261, the drive motor 261 is electrically connected to a valve in the control valve body 260, and the drive motor 261 rotates to control the valve to rotate to implement opening or closing of the control pump 26. Therefore, opening or closing of the control pump 26 is implemented through cooperation between the drive motor 261 and the valve, so that relatively reliable operation of the control pump 26 can be ensured, to reduce impact of oil on opening or closing of the control pump 26.

According to some embodiments of the present disclosure, as shown in FIG. 1, the hydraulic active suspension 1000 further includes a pressure relief valve 31, and the pressure relief valve 31 is located at an outlet port of the control pump 26. When pressure of a liquid outlet of the control pump 26 reaches a threshold, the pressure relief valve 31 is opened to relieve pressure, to ensure that the hydraulic active suspension 1000 is in a normal pressure range. It should be noted that a working principle of the pressure relief valve 31 is a related art, and therefore is not described in detail herein.

In some embodiments of the present disclosure, as shown in FIG. 1, the hydraulic active suspension 1000 further includes a pressure-stabilizing accumulator 29, and the pressure-stabilizing accumulator 29 is arranged at an outlet end of the control pump 26, so that the pressure-stabilizing accumulator 29 can stabilize pressure and eliminate flow amount fluctuation at the outlet end of the control pump 26.

In some embodiments of the present disclosure, as shown in FIG. 1 and FIG. 2, the piston rod 203 is a hollow piston rod, an oil channel 204 is arranged in the piston rod 203, the oil channel 204 is connected to the lower chamber 2012, and the common channel is connected to the oil channel 204.

It can be understood that, in a driving process of the vehicle, the axle may vibrate, for example, shake, relative to the body. When the hydraulic active suspension 1000 according to the embodiments of the present disclosure is installed on the vehicle, the housing 201 is installed on the axle, and the piston rod 203 is connected to the body. Therefore, it can be learned that a top end of the piston rod 203 and the body are relatively stationary, and the housing 201 can move with the axle relative to the piston rod 203. Because the oil channel 204 in the piston rod 203 is connected to the common channel, impact of vibration of the axle on a connection part of the common channel can be reduced, the common channel can be stably connected, abrasion at a connection part between the common channel and the liquid storage apparatus can be reduced, and abrasion at a connection part between the common channel and the piston rod 203 can be reduced.

The following describes a hydraulic active suspension according to a example of the present disclosure with reference to FIG. 1. It should be noted that the foregoing examples are merely example descriptions, but not limitative descriptions, and example modifications can be made to the examples based on actual cases.

As shown in FIG. 1, a hydraulic active suspension 1000 according to embodiments of the present disclosure includes a left front shock absorber assembly 2, a right front shock absorber assembly 2, a left rear shock absorber assembly 2, a right rear shock absorber assembly 2, an accumulator module, a liquid receiver 1, a control pump 26, an oil return valve 27, a one-way valve 28, a pressure-stabilizing accumulator 29, a pressure relief valve 31, and a second control valve 8. The accumulator module includes a first accumulator 9, a second accumulator 10, and a third accumulator 30.

The left front shock absorber assembly 2 and the right front shock absorber assembly 2 each include a shock absorber 200 and a shock absorber spring 205. The shock absorber spring 205 is sleeved and fastened onto the shock absorber 200. The left rear shock absorber assembly 2 and the right rear shock absorber assembly 2 each include a shock absorber 200 and a shock absorber spring 205. The shock absorber spring 205 and the shock absorber 200 are arranged in parallel. Two ends of a shock absorber spring 205 of the left rear shock absorber assembly 2 are respectively connected to the body and the axle. Two ends of a shock absorber spring 205 of the right rear shock absorber assembly 2 are respectively connected to the body and the axle. Each shock absorber 200 includes a housing 201, a piston rod 203, and a piston 202. The piston rod 203 is connected to the piston 202. The piston 202 is movably arranged in the housing 201 to define an upper chamber 2011 and a lower chamber 2012. An oil channel 204 is arranged in the piston rod 203. The oil channel 204 is in communication with the lower chamber 2012. An oil channel 204 of each shock absorber assembly 2 is connected to a liquid storage apparatus through a common channel. A first control valve 3 is arranged on each common channel.

The liquid receiver 1 has a liquid outlet and a liquid inlet. The control pump 26 is separately connected to the liquid outlet and the common channel to guide oil in the liquid receiver 1 to the common channel. The oil return valve 27 is separately connected to the liquid inlet and the common channel. When the oil return valve 27 is opened, oil flows from the common channel to the liquid inlet. The one-way valve 28 is arranged at an outlet end of the control pump 26 and provides one-way communication. The pressure-stabilizing accumulator 29 is arranged at the outlet end of the control pump 26 and is located between the one-way valve 28 and the control pump 26. The pressure-stabilizing accumulator 29 can stabilize and eliminate flow amount fluctuation at the outlet end of the control pump 26.

A first control valve 3 corresponding to each shock absorber assembly 2 is connected on a corresponding common channel in series. The first control valve 3 is configured to control communication or cutoff of the common channel.

A second accumulator 10 corresponding to each shock absorber assembly 2 is connected to the common channel. A third control valve 11 is arranged at an oil inlet/outlet of the second accumulator 10. The third control valve 11 is in a normally closed state.

A second control valve 8, a first accumulator 9, and a fourth control valve 12 are further arranged on each common channel. The second control valve 8 is configured to adjust a flow amount of the corresponding common channel to adjust damping of the hydraulic active suspension 1000. The first accumulator 9 can store energy. The fourth control valve 12 is arranged between the first accumulator 9 and a second accumulator 10.

One third accumulator 30 is correspondingly arranged for each shock absorber assembly 2. A third accumulator 30 corresponding to the left front shock absorber assembly 2 is located between a first accumulator 9 and a corresponding oil channel 204. A third accumulator 30 corresponding to the right front shock absorber assembly 2 is located between a first accumulator 9 and a corresponding oil channel 204. A third accumulator 30 corresponding to the left rear shock absorber assembly 2 is located between a first accumulator 9 and a second accumulator 10. A third accumulator 30 corresponding to the right rear shock absorber assembly 2 is located between a first accumulator 9 and a second accumulator 10.

Specifically, the hydraulic active suspension 1000 has a pressurizing mode, a lifting mode, and a height reduction mode. In the pressurizing mode, first control valves 3 are opened, fourth control valves 12 are closed, third control valves 11 are opened, and the control pump 26 operates and therefore oil in the liquid receiver 1 respectively flows to corresponding second accumulators 10 through four common channels to store energy. After energy is stored for each second accumulator 10, the third control valves 11 are closed.

In the lifting mode, oil in the liquid receiver 1 or oil in accumulator modules can enter the oil channel 204 of the left front shock absorber assembly 2, the oil channel 204 of the right front shock absorber assembly 2, an oil channel 204 of the left rear shock absorber assembly 2, and an oil channel 204 of the right rear shock absorber assembly 2, and hydraulic oil entering each oil channel 204 flows into a lower chamber 2012, so that hydraulic pressure in the lower chamber 2012 increases and therefore a piston 202 moves upward. When the piston 202 moves upward, a piston rod 203 is driven to move upward. A piston rod 203 of the left front shock absorber assembly 2 moves upward, a piston rod 203 of the right front shock absorber assembly 2 moves upward, a piston rod 203 of the left rear shock absorber assembly 2 moves upward, and a piston rod 203 of the right rear shock absorber assembly 2 moves upward, to drive the body to move upward, thereby lifting the body.

In the height reduction mode, the control pump 26 stops working. Under a gravity action of the vehicle, oil can separately flow from the oil channel 204 of the left front shock absorber assembly 2, the oil channel 204 of the right front shock absorber assembly 2, the oil channel 204 of the left rear shock absorber assembly 2, and the oil channel 204 of the right rear shock absorber assembly 2, and hydraulic pressure in the lower chamber 2012 of each shock absorber 200 decreases and therefore the piston 202 moves downward. When the piston 202 moves downward, the piston rod 203 is driven to move downward. The piston rod 203 of the left front shock absorber assembly 2 moves downward, the piston rod 203 of the right front shock absorber assembly 2 moves downward, the piston rod 203 of the left rear shock absorber assembly 2 moves downward, and the piston rod 203 of the right rear shock absorber assembly 2 moves downward, to drive the body to move downward, thereby reducing the body height. It can be understood that, in the height reduction mode, oil discharged from each shock absorber assembly 2 can be directly discharged to the liquid receiver 1, can be discharged to an accumulator assembly for energy storage, or can be discharged to both the liquid receiver 1 and the accumulator assembly.

When pressure in the hydraulic active suspension 1000 is relatively large, for example, it is detected that a pressure at the outlet of the control pump 26 reaches a threshold (30 MPa), the oil return valve 27 is opened to relieve pressure, to ensure that the hydraulic active suspension 1000 is in a normal pressure range. In this case, oil in each shock absorber 200 can flow into the liquid receiver 1 through a common channel and the oil return valve 27.

After the pressure relief, if pressure in the hydraulic active suspension 1000 is still relatively large or is relatively large in an operation process, the pressure relief valve 31 can be opened to relieve pressure, to ensure reliable working of the entire hydraulic active suspension 1000.

In a driving process of the vehicle, if damping of the hydraulic active suspension 1000 is relatively small, the body is relatively bumpy and therefore comfort is affected. Therefore, an amount of oil in each common channel can be adjusted by using a second control valve 8, to adjust the damping of the hydraulic active suspension 1000. When opening of the second control valve 8 is reduced and therefore an amount of oil that can flow through the common channel decreases, an amount of oil entering the common channel from a shock absorber decreases, to increase the damping. When the opening of the second control valve 8 is increased, an amount of oil entering the common channel from the shock absorber increases, to reduce the damping. Therefore, the damping of the hydraulic active suspension 1000 can be reliably adjusted.

When stiffness of the hydraulic active suspension 1000 is relatively large and therefore vehicle comfort is reduced, the third control valves 11 can be controlled to be opened, and oil in the second accumulators 10 can be a supplement to each common channel, so that the stiffness of the hydraulic active suspension 1000 can be reduced, and a bump buffering effect of the hydraulic active suspension 1000 can be improved.

In a driving process of the vehicle, if the vehicle is hit by a bump or the like, oil in a lower chamber 2012 of each shock absorber assembly 2 can enter the third accumulator 30 through the oil channel 204 to store energy, to implement fast pressure reduction. Because driving stability needs to be ensured for a front axle of the vehicle, and comfort mainly needs to be ensured for a rear axle of the vehicle, the third accumulator 30 corresponding to the left front shock absorber assembly 2 is located between the first accumulator 9 and the corresponding oil channel 204, and the third accumulator 30 corresponding to the right front shock absorber assembly 2 is located between the first accumulator 9 and the corresponding oil channel 204, thereby implementing fast pressure relief.

A vehicle according to embodiments of the present disclosure includes the hydraulic active suspension 1000 according to any one of the foregoing embodiments of the present disclosure.

According to the vehicle in the embodiments of the present disclosure, the hydraulic active suspension 1000 according to any one of the foregoing embodiments is arranged, so that the body height can be adjusted, and vehicle operation stability can be improved without compromising vehicle comfort, thereby effectively resolving a contradiction between the vehicle comfort and the operation stability. In addition, the stiffness and the damping can be further adjusted, so that the vehicle on which the hydraulic active suspension 1000 is arranged drives more stably. In addition, a flow path between the liquid storage apparatus and the lower chamber 2012 overlaps a flow path between the accumulator module and the lower chamber 2012. Therefore, the number of connection pipelines can be reduced, so that the structure of the entire hydraulic active suspension 1000 is compact, thereby facilitating space arrangement of the complete vehicle.

In the descriptions of the present disclosure, it should be understood that orientation or position relationships indicated by the terms such as “center”, “longitudinal”, “transverse”, “length”, “width”, “thickness”, “on”, “under”, “front”, “rear”, “left”, “right”, “vertical”, “horizontal”, “top”, “bottom”, “inside”, “outside”, “clockwise”, “anticlockwise”, “axial direction”, “radial direction”, and “circumferential direction” are orientation or position relationships shown based on accompanying drawings, and are used merely for ease of describing the present disclosure and brevity of description, rather than indicating or implying that indicated apparatuses or components must have particular orientations or must be constructed and operated in particular orientations. Therefore, such terms should not be construed as limitations to the present disclosure.

In addition, terms “first” and “second” are used merely for the purpose of description, and shall not be construed as indicating or implying relative importance or implying the number of indicated technical features. Therefore, a feature limited by “first” or “second” may explicitly or implicitly include one or more such features. In the descriptions of the present disclosure, “a plurality of” means two or more, unless otherwise definitely and specifically limited.

In the present disclosure, unless otherwise explicitly specified or defined, the terms such as “install”, “connect”, “connection”, and “fasten” should be understood in a broad sense. For example, the connection may be a fastened connection, a detachable connection, or an integral connection; the connection may be a mechanical connection or an electrical connection; or the connection may be a direct connection, an indirect connection through an intermediate medium, internal communication between two components, or an interaction relationship between two components. A person of ordinary skill in the art may understand meanings of the foregoing terms in the present disclosure based on cases.

In the present disclosure, unless otherwise explicitly specified or defined, that a first feature is “on” or “under” a second feature may be that the first feature is in direct contact with the second feature, or the first feature is in indirect contact with the second feature through an intermediate medium. In addition, that a first feature is “over”, “above”, or “on” a second feature may be that the first feature is directly above or obliquely above the second feature, or may merely indicate that a horizontal position of the first feature is higher than that of the second feature. That a first feature is “beneath”, “below”, or “under” a second feature may be that the first feature is directly below or obliquely below the second feature, or may merely indicate that a horizontal position of the first feature is lower than that of the second feature.

In the descriptions of this specification, a description of a reference term such as “an embodiment”, “some embodiments”, “an example”, “a specific example”, or “some examples” means that a feature, structure, material, or characteristic that is described with reference to the embodiment or the example is included in at least one embodiment or example of the present disclosure. In this specification, schematic descriptions of the foregoing terms are not necessarily directed at the same embodiment or example. In addition, described features, structures, materials, or characteristics may be combined in proper manners in any one or more embodiments or examples. In addition, a person skilled in the art may integrate or combine different embodiments or examples described in the specification and features of the different embodiments or examples provided that there is no contradiction.

Although the embodiments of the present disclosure have been shown and described above, it can be understood that, the foregoing embodiments are examples and should not be understood as limitations to the present disclosure. A person of ordinary skill in the art can make changes, modifications, replacements, or variations to the foregoing embodiments within the scope of the present disclosure.

What is claimed is:

1. A hydraulic active suspension, configured for a vehicle, comprising: a shock absorber, a common channel, an accumulator module, and a liquid storage apparatus, the shock absorber having a housing, a piston, and a piston rod, the housing being configured to be connected to a wheel or an axle, the piston being located in the housing and defining an upper chamber and a lower chamber of the shock absorber, one end of the piston rod being connected to the piston, the other end of the piston rod projecting out of the housing and being configured to be connected to a body, both the liquid storage apparatus and the accumulator module being in communication with the lower chamber through the common channel, the liquid storage apparatus being configured to adjust a height of the vehicle, and the accumulator module being configured to adjust at least one of stiffness and damping of the shock absorber.

2. The hydraulic active suspension according to claim 1, wherein a first end of the common channel is in communication with the lower chamber, a second end of the common channel is in communication with the liquid storage apparatus, a module connection part is arranged on the common channel, and the module connection part is located between the first end and the second end and is configured to be in communication with the accumulator module.

3. The hydraulic active suspension according to claim 2, wherein a first control valve is arranged on the common channel, and the first control valve is arranged between the second end and the module connection part.

4. The hydraulic active suspension according to claim 2, wherein the module connection part comprises a first connection point, the accumulator module comprises a first accumulator and a second control valve, the first accumulator is in communication with the first connection point, the second control valve is arranged between the first connection point and the lower chamber, and the second control valve is one of an adjustment valve, a cutoff valve, and a cutoff adjustment valve; and when the second control valve is the adjustment valve, the second control valve is configured to adjust opening to adjust the damping of the shock absorber; when the second control valve is the cutoff valve, the second control valve is configured to adjust the stiffness; or when the second control valve is the cutoff adjustment valve, the second control valve is configured to adjust the stiffness and the damping of the shock absorber.

5. The hydraulic active suspension according to claim 3, wherein the module connection part comprises a first connection point, the accumulator module comprises a first accumulator and a second control valve, the first accumulator is in communication with the first connection point, the second control valve is arranged between the first connection point and the lower chamber, and the second control valve is one of an adjustment valve, a cutoff valve, and a cutoff adjustment valve; and when the second control valve is the adjustment valve, the second control valve is configured to adjust opening to adjust the damping of the shock absorber; when the second control valve is the cutoff valve, the second control valve is configured to adjust the stiffness; or when the second control valve is the cutoff adjustment valve, the second control valve is configured to adjust the stiffness and the damping of the shock absorber.

6. The hydraulic active suspension according to claim 2, wherein the module connection part further comprises a second connection point, the accumulator module comprises a second accumulator and a third control valve, the second accumulator is in communication with the second connection point, and the third control valve is arranged between the second accumulator and the second connection point and selectively communicates the second connection point with the second accumulator.

7. The hydraulic active suspension according to claim 3, wherein the module connection part further comprises a second connection point, the accumulator module comprises a second accumulator and a third control valve, the second accumulator is in communication with the second connection point, and the third control valve is arranged between the second accumulator and the second connection point and selectively communicates the second connection point with the second accumulator.

8. The hydraulic active suspension according to claim 4, wherein the module connection part further comprises a second connection point, the accumulator module comprises a second accumulator and a third control valve, the second accumulator is in communication with the second connection point, and the third control valve is arranged between the second accumulator and the second connection point and selectively communicates the second connection point with the second accumulator.

9. The hydraulic active suspension according to claim 5, wherein the module connection part further comprises a second connection point, the accumulator module comprises a second accumulator and a third control valve, the second accumulator is in communication with the second connection point, and the third control valve is arranged between the second accumulator and the second connection point and selectively communicates the second connection point with the second accumulator.

10. The hydraulic active suspension according to claim 2, wherein the module connection part comprises a first connection point and a second connection point, the accumulator module comprises a first accumulator, a second accumulator, a second control valve, and a third control valve, the first accumulator is connected to the first connection point, the second accumulator is connected to the second connection point, the second control valve is connected between the first connection point and the lower chamber, the third control valve is arranged between the second accumulator and the second connection point, the second control valve is the adjustment valve to adjust the damping of the shock absorber, and the third control valve is the cutoff valve to adjust the stiffness of the shock absorber.

11. The hydraulic active suspension according to claim 9, wherein the module connection part comprises a first connection point and a second connection point, the accumulator module comprises a first accumulator, a second accumulator, a second control valve, and a third control valve, the first accumulator is connected to the first connection point, the second accumulator is connected to the second connection point, the second control valve is connected between the first connection point and the lower chamber, the third control valve is arranged between the second accumulator and the second connection point, the second control valve is the adjustment valve to adjust the damping of the shock absorber, and the third control valve is the cutoff valve to adjust the stiffness of the shock absorber.

12. The hydraulic active suspension according to claim 10, wherein the first connection point is arranged on a side of the second connection point away from the second end.

13. The hydraulic active suspension according to claim 11, wherein the first connection point is arranged on a side of the second connection point away from the second end.

14. The hydraulic active suspension according to claim 10, wherein a fourth control valve is arranged between the first connection point and the second connection point.

15. The hydraulic active suspension according to claim 13, wherein a fourth control valve is arranged between the first connection point and the second connection point.

16. The hydraulic active suspension according to claim 2, wherein the shock absorber is a front-axle shock absorber, a third connection point is arranged between the module connection part and the first end, the hydraulic active suspension further comprises a third accumulator, and the third accumulator is in communication with the third connection point.

17. The hydraulic active suspension according to claim 15, wherein the shock absorber is a front-axle shock absorber, a third connection point is arranged between the module connection part and the first end, the hydraulic active suspension further comprises a third accumulator, and the third accumulator is in communication with the third connection point.

18. The hydraulic active suspension according to claim 6, wherein the shock absorber is a rear-axle shock absorber, the module connection part further comprises a third connection point, the third connection point is located between the first connection point and the second connection point, the accumulator module comprises a third accumulator, and the third accumulator is in communication with the third connection point.

19. The hydraulic active suspension according to claim 15, wherein the shock absorber is a rear-axle shock absorber, the module connection part further comprises a third connection point, the third connection point is located between the first connection point and the second connection point, the accumulator module comprises a third accumulator, and the third accumulator is in communication with the third connection point.

20. A vehicle, comprising the hydraulic active suspension according to claim 1.
